(19) United States
(12) Patent Application Publication
(10) Pub. No.: US 2007/0284240 A1
(43) Pub. Date: Dec. 13, 2007

(54) System and method for diagnosing and troubleshooting amine regeneration system

(76) Inventors: Roy Wade Rhodes, Beyan, TX (US); Quenten Zane Rhodes, College Station, TX (US)

Correspondence Address: MCHALE & SLAVIN, P.A., 2855 PGA BLVD, PALM BEACH GARDENS, FL, 33410, US

(21) Appl. No.: 11/756,258

(22) Filed: May 31, 2007

Related U.S. Application Data
(60) Provisional application No. 60/812,050, filed on Jun. 9, 2006.

(51) Int. Cl. B01J 20/34; B01D 3/38

(52) U.S. Cl. 203/88; 502/56; 203/95; 203/98; 202/176

(57) ABSTRACT

A system for optimized operation and troubleshooting/diagnosis of an amine regeneration system comprising a flash tank, a rich/lean heat exchanger, a still, a reflux condenser, a reflux accumulator, a pump, a reboiler, and a pump bypass line to the flash tank.

### CROSS-REFERENCE TO RELATED APPLICATIONS

This application claims benefit of the filing date of Provisional Patent Application 60/812,050, file Jun. 9, 2006, the contents of which are herein incorporated by reference.

### FIELD OF THE INVENTION

This invention relates to the regeneration of amine used in the processing of natural gas. Specifically, the invention involves novel component configurations to increase ease of startup and operations for the amine regeneration system. The regenerated amine can then be reused to remove carbon dioxide and hydrogen sulfide from the natural gas stream.

### BACKGROUND OF THE INVENTION

Acid gas removal from gas streams, particularly removal of hydrogen sulfide and carbon dioxide from gas streams formed in refinery process units, synthesis gas production plants and oil and gas production facilities, is necessary to allow this gas to be used and/or sold into pipeline systems. The removal of sulfur compounds from these acid gasses or “sour gasses” is called “sweetening.” Typically, acid gases are removed using an amine-based solvent to absorb the acid gas via various chemical reactions, resulting in the production of a rich amine solvent, which can then be regenerated using heat.

Hydrogen sulfide is a toxic gas that must generally be removed to extreme low concentrations (less than 0.25 grains of H₂S per 100 standard cubic feet) prior to pipeline delivery. When mixed with free water it forms a weak acid that can cause corrosion.

Carbon dioxide is a non-toxic inert gas. Carbon dioxide, as such, is harmless in dry natural gas but when mixed with free water will form a weak acid and also cause corrosion. Inlet gas to cryogenic plants that contain concentrations of CO₂ in excess of 0.75 to 1.0 percent CO₂ may cause freezing problems. The CO₂ will freeze to a solid ice in a turbo expander plant demethanizer where it may plug lines and even plug the tower itself. Often flooding of the demethanizer results from carbon dioxide freezing within the tower. When the plant inlet gas contains concentrations of carbon dioxide too high to process, all of the gas may be treated or part of the gas may be separated into a side stream and treated by an amine plant. Principally all the carbon dioxide is removed in the amine plant. When the side stream is processed, and sufficient gas is treated, it is blended back with the untreated gas, thus yielding a carbon dioxide content of the blended stream which is low enough for processing. Carbon dioxide also lowers the heating value of the gas stream which is usually specified as 1000 BTU/scf.

There are generally two types of gas treating processes: (a) absorption and (b) adsorption. In absorption processes, the gas stream contacts a liquid that selectively removes acid gases. The most common absorption process is the amine process. The liquid absorbent is a mixture of water and a chemical amine, usually monoethanol-amine (MEA) or diethanolamine (DEA). Sometimes triethanol-amine (TEA), diglycolamine (DGA), and methyl-diethanolamine (MDEA), diisopropylamine, sulfanol and solutions of these, with special additives to improve efficiencies, are utilized.

Amines remove carbon dioxide and hydrogen sulfide by a chemical reaction that changes the chemical form of both the amine and the acid gases. The new chemical changes the acid gases to a liquid form which is separated from the acid-free gas or sweetened gas. The chemical reaction between amine (called lean amine at the start of the process) and acid gases gives off heat when the reaction takes place. The sweet residue gas flows out the top of a contactor or absorber and the reacted amine (also called rich amine) flows out the bottom and is generally higher in temperature than the inlets. Lean amine is regenerated by reducing the pressure and adding heat to the rich amine.

The “Fifth Edition Gas Purification” by Arthur Kohl and Richard Nielsen (Gulf Publishing, 1960 to 1997) illustrates various processes for the purification of gases utilizing amine solvents and illustrates processes for regeneration of the amine solvents. Particularly preferred amine-based solvents include secondary and tertiary amines (e.g., diethanolamine [DEA], and/or methyldiethanolamine [MDEA]), which are generally more energy efficient than primary amines due to their lower heat of reaction and lower energy requirements for regeneration. Alternative amine solvents may further include monoethanolamine [MEA], diglycolamine [DGA], triethanolamine [TEA], diisopropylamine, and various combinations thereof, along with one or more additives.

The effectiveness of a particular amine solvent to absorb acid gases to meet the treated gas specification typically depends on the residual acid gas content in the lean amine, which in turn is a function of the particular regeneration method and conditions. The lower the acid gas content in the lean amine, the more effective the acid gas absorption process. Therefore, a variety of approaches have been undertaken to improve the current acid gas absorption and regeneration processes.

While numerous prior art processes and systems for acid gas absorption and solvent regeneration are known in the art, many suffer from one or more disadvantages or inefficiencies.

### DESCRIPTION OF THE PRIOR ART

U.S. Pat. No. 4,152,217 to Eisenberg et al teaches an amine regeneration system which utilizes a split rich amine stream wherein one stream is routed directly to the top of an amine regenerator column and the second stream is routed to a heat exchanger where it is heated en route to an intermediate point of the regenerator column. The spent amine stream which is passed without prior heating directly to the top of the regenerator column is heated by condensing steam in the column which would normally escape therefrom, thereby reducing the amount of “saturation” steam which is lost from the system, thereby reducing the overall energy requirements for the system.

U.S. Pat. No. 4,461,749 to Thorn is directed to a method of processing acid gases wherein makeup water is distilled internally in an amine gas treating unit by adding it to the reclaimer used to process a slipstream of lean amine from the stripper.

U.S. Pat. No. 4,798,910 to Herrin teaches a method for amine regeneration wherein a rich amine out of a first heat exchanger is temperature controlled prior to transfer to a second heat exchanger. At least a portion of the hot overhead gasses exiting from a stripping still are transferred to the second heat exchanger. Temperature controlled heated rich amine liquid passes through the second exchanger and contacts the hot overhead gasses. The rich amine liquid is increased in higher temperature thereby and then is transferred to yet a third exchanger and finally to the stripping still for regeneration of lean amine. The reduced temperature overhead gasses are transferred to the reflux condenser for final cooling.

U.S. Pat. No. 6,071,484 to Dingman, et al. describe a method to produce an ultra lean amine using an ion exchange bed to remove the residual acid gases in the lean amine.

U.S. Pat. No. 4,798,910 to Herrin, teaches the use of an additional heat exchanger to heat the rich amine solvent using a portion of the heat content in the regenerator overhead gases. This method reduces overhead condenser duty to some degree, however reboiler duty remains largely unaffected, as the amine regeneration process is more strongly dependent on the stripping steam supplied at the bottom of the regenerator.

U.S. Pat. No. 3,565,573 to Thirkell teaches a process in which acid gas is treated in a dual-zone absorber to provide a rich solvent that is regenerated in conventional manner.

U.S. Pat. No. 3,829,521 to Green et al, similarly describe a configuration in which a pre-stripper and a stripper operate in series to remove acid gas from two gas streams.

These references fail to address the start-up problems and process inefficiencies of amine regeneration plants which are the subject of the instant invention. The improved configurations and methods for solvent regeneration disclosed herein therefore solve a long-felt need in the art.

### SUMMARY OF THE INVENTION

In accordance with the present invention, amine regeneration is accomplished via a system consisting of a flash tank, a rich/lean heat exchanger, a still, a reflux condenser, a reflux accumulator, a pump, a reboiler, and a pump bypass line to the flash tank (instead of the contactor).

Accordingly, it is an objective of the instant invention to allow the regeneration system to be isolated from the adsorber system while in operation.

It is a further objective of the instant invention to utilize this isolation to find faults with the regeneration system.

It is yet another objective of the instant invention to reduce downtime allowing the operator to regenerate the amine without the need for natural gas to be flowing, thereby reducing the volume of out of specification natural gas generated and also reducing operator time for the system to “settle out.”

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 shows the flow of contaminated amine through its separation into clean amine and acid gas.

FIG. 2 shows a prior art system lacking the pump bypass assembly of the instant invention.

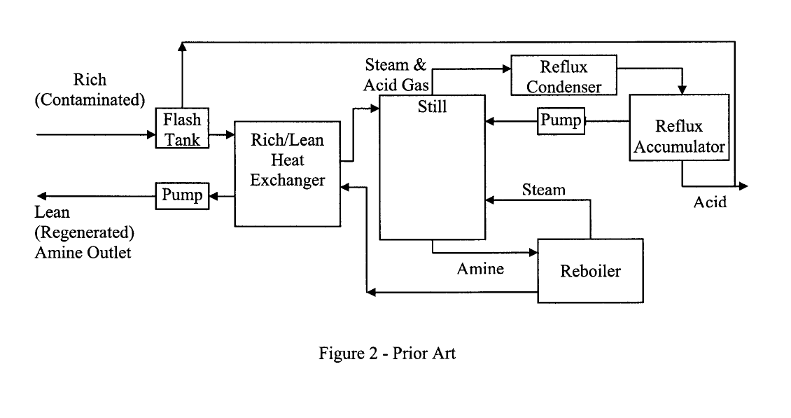

### DETAILED DESCRIPTION OF THE INVENTION

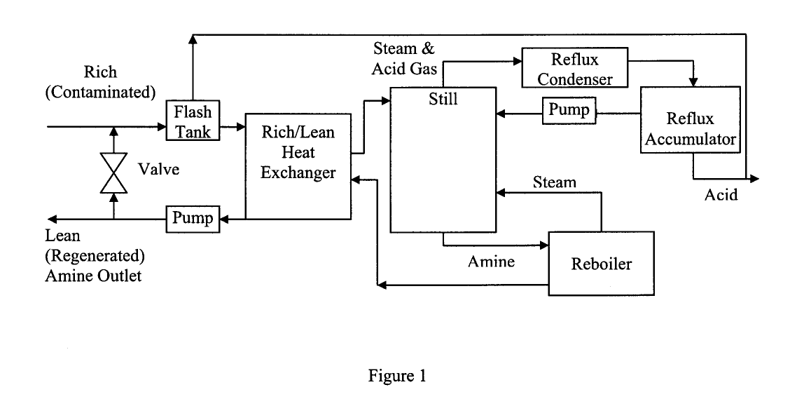

A preferred method for optimizing operation of an amine regeneration system is set forth in FIG. 1. This method includes the steps of:

providing a pump bypass assembly comprised of a pump bypass line and associated valving in fluid communication with a flash tank, whereby pump discharge of a lean regenerated amine stream may be directed to the flash tank thereby enabling all major regeneration system components to remain operable without requiring exiting of amine from the regeneration system;

passing a rich amine input stream through the flash tank wherein a pressure differential enables flashing off of a portion of acid gas from the rich amine input stream;

heating the input rich amine stream by passage thereof through a rich/lean heat exchanger to form a heated rich amine stream;

releasing acid gas components from the heated rich amine stream by passage of the heated rich amine stream into a still wherein the heated rich amine stream is subjected to an initial steam contact thereby causing it to release acid gas components and form a lean amine stream;

feeding the resultant lean amine stream to a reboiler where it is heated to produce additional steam;

introducing the additional steam to the still whereby it contacts the heated rich amine stream and exits the still as an overhead admixture including the acid gas components;

recovering water from the overhead stream by passage thereof through a reflux condenser whereby acid gas components exit to waste;

storing the recovered water in a reflux accumulator for subsequent pumping to the still; and

passing the lean amine stream from the reboiler to the rich/lean heat exchanger wherein it is cooled and exits the system fully regenerated;

whereby operation of the pump bypass assembly to provide fluid communication with the flash tank, whereby pump discharge of a lean regenerated amine stream may be directed to the flash tank, enables the amine to be fully regenerated while simultaneously enabling the regeneration system to be isolated for troubleshooting needs.

The present invention provides a pump bypass assembly comprised of a pump bypass line to the flash tank and associated valving, which allows the pump discharge to be directed to the flash tank (instead of the reboiler). This allows all of the major regeneration system components, for example the flash tank, rich/lean heat exchanger, still, reflux condenser, reflux accumulator, reboiler and associated fluid handling components, to be used without the need for the amine to leave the regeneration system. This further allows the amine to be fully regenerated and it allows for the regeneration system to be isolated for troubleshooting needs.

### Advantages

From the description above, a number of advantages of the amine regeneration facility become evident:

The time needed for troubleshooting is reduced and, therefore, operating cost is reduced by allowing the regeneration system to be isolated from the adsorber system while in operation.

The operating costs will be further reduced by allowing the operator to regenerate the amine without the need for natural gas to be flowing, reducing out of specification natural gas and operator time for the system to “settle out.”

### Operation—FIG. 1

The contaminated amine is introduced into the flash tank releasing some of the acid gas components and then it goes into the rich/lean heat exchanger causing the rich amine to be heated. The rich amine is then introduced into the still where it comes in contact with steam as it goes down through the still. The amine releases the acid gas components which exit the still with the steam, and they are carried into the reflux condenser. The steam condenses in the reflux condenser, and then the water stream enters the reflux accumulator where the acid gas exits the system. The condensed water is stored in the reflux accumulator until it is pumped back into the still. The amine exits the still and enters the reboiler where it is heated to release steam which is fed into the still. The fully regenerated amine is passed into the rich/lean heat exchanger where it is cooled and exits the system as fully regenerated amine. The pump bypass assembly, comprised of a pump bypass line to the flash tank and associated valving, is operated as desired, to direct the lean amine pump discharge to the flash tank (instead of the reboiler). This allows all of the major regeneration system components, for example the flash tank, rich/lean heat exchanger, still, reflux condenser, reflux accumulator, reboiler and associated fluid handling components, to be used without the need for the amine to leave the regeneration system. This further allows the amine to be fully regenerated and it allows for the regeneration system to be isolated for troubleshooting needs.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method for optimizing operation and diagnosis of an amine regeneration system comprising:
(a) providing a pump bypass assembly comprised of a pump bypass line and associated valving in fluid communication with a flash tank, whereby pump discharge of a lean regenerated amine stream may be directed to said flash tank thereby enabling all major regeneration system components to remain operable without requiring exiting of amine from the regeneration system;
(b) passing a rich amine input stream through said flash tank wherein a pressure differential enables flashing off of a portion of acid gas from said rich amine input stream;
(c) heating said input rich amine stream by passage thereof through a rich/lean heat exchanger to form a heated rich amine stream;
(d) releasing acid gas components from said heated rich amine stream by passage of said heated rich amine stream into a still wherein said heated rich amine stream is subjected to an initial steam contact thereby causing it to release acid gas components and form a lean amine stream;
(e) feeding said resultant lean amine stream to a reboiler where it is heated to produce additional steam;
(f) introducing said additional steam to said still whereby it contacts said heated rich amine stream and exits said still as an overhead admixture including said acid gas components;
(g) recovering water from said overhead stream by passage thereof through a reflux condenser whereby acid gas components exit to waste;
(h) storing said recovered water in a reflux accumulator for subsequent pumping to said still; and
(i) passing said lean amine stream from said reboiler to said rich/lean heat exchanger wherein it is cooled and exits said system fully regenerated;
whereby operation of said pump bypass assembly to provide fluid communication with said flash tank, whereby pump discharge of a lean regenerated amine stream may be directed to said flash tank amine, enables said amine to be fully regenerated while simultaneously enabling the regeneration system to be isolated for troubleshooting needs.

2. A system for optimizing operation and diagnosis of an amine regeneration system comprising:
(a) a pump bypass assembly comprised of a pump bypass line and associated valving in fluid communication with a flash tank, whereby pump discharge of a lean regenerated amine stream is directed to said flash tank;
(b) a flash tank pressurization assembly, in fluid communication with a source of pressurized acid gas and further in fluid communication with a flash tank, said flash tank being constructed and arranged to flash off a portion of acid gas contained within an input rich amine stream;
(c) a rich/lean heat exchanger for heating said input rich amine stream to form a heated rich amine stream;
(d) a still wherein said heated rich amine stream is subjected to an initial steam contact thereby causing it to release acid gas components and form a lean amine stream;
(e) a reboiler for heating said lean amine stream to produce additional steam;
(f) means for introducing said additional steam to said still whereby it contacts said heated rich amine stream and exits said still as an overhead admixture including said acid gas components;
(g) a reflux condenser for recovering water from said overhead stream for storage and separation of said acid gas components to waste;
(h) a reflux accumulator for storing said recovered water and subsequently pumping to said still; and
(i) means for passing said lean amine stream from said reboiler to said rich/lean heat exchanger wherein it is cooled and exits said system fully regenerated;
whereby directing said lean amine stream from said pump discharge to said flash tank permits all major regeneration system components to remain operable without requiring exiting of amine from the regeneration system and enables diagnosis of regeneration system components.
